(19) United States
(12) Patent Application Publication
(10) Pub. No.: US 2001/0045451 A1
(43) Pub. Date: Nov. 29, 2001

(54) Method and system for token-based authentication

(76) Inventors: Warren Yung-Hang Tan, Thousand Oaks, CA (US); Joe Hsu, Northridge, CA (US); Fred Pinn, Studio City, CA (US)

Correspondence Address: George T. Marcou, Esq., Kilpatrick Stockton LLP, Suite 800, 700 13th Street, N.W., Washington, DC, 20005, US

(21) Appl. No.: 09/792,785

(22) Filed: Feb. 23, 2001

Related U.S. Application Data
(60) Provisional application No. 60/185,579, filed on Feb. 28, 2000.

(51) Int. Cl. G06K 7/00

(52) U.S. Cl. 235/375; 235/435; 235/485

(57) ABSTRACT

A method and system for token based user access authentication enables secure user access to a web server using a token, such as a smart card, and provides a single sign-on mechanism which does not employ a user name and password in the log on process. Instead, a smart card with a certificate enables the user at a client workstation to log on by authenticating himself or herself to the smart card with a Personal Identification Number (PIN). The smart card then uses mutual authentication to verify the identity of the cardholder and the access server and establishes a secure link between the client workstation and the access server with Secure Sockets Layer (SSL) protocol.

### PRIORITY APPLICATION

This application claims the benefit of U.S. Provisional Application No. 60/185,579 filed Feb. 28, 2000 and entitled “Method and System for Token-Based Authentication,” incorporated herein by this reference.

### CROSS REFERENCE TO RELATED APPLICATION

This application relates to co-pending U.S. patent application Ser. No. 09/688,112 filed Sep. 22, 2000, entitled “Method and System for Single Sign-On User access to Multiple Web Servers” which claimed the benefit of U.S. Provisional Application No. 60/155,853 filed Sep. 24, 1999, each of which is incorporated herein by this reference.

### FIELD OF THE INVENTION

The present invention relates generally to the field of access authentication into a website and more particularly to a method and system for user access authentication to a website using a smart card.

### BACKGROUND OF THE INVENTION

The invention disclosed in co-pending application U.S. patent application Ser. No. 09/688,112 filed Sep. 22, 2000, entitled “Method and System for Single Sign-On User Access to Multiple Web Servers” (“single sign-on mechanism”) provides for single sign-on user access to a federation of web servers that allows a user already authenticated on one website to have access, for example, to another website without having to be re-authenticated via provision of a valid user name and password. The single sign-on mechanism enables user authentication at the first website, selection of the second website's Uniform Resource Locator (URL), and passage of an authentication token by the first website server to the second website server that contains sufficient information for the second website server to recognize the user as a valid user.

In other words, with the single sign-on mechanism, once the user goes into the Internet, logging in to one web server using the typical user path, that particular web server generates an authentication cookie which allows the user to access the other web server under the same domain. However, the process of logging in by the user is typically performed by simply entering a static user name and password, which provides little, if any, security.

### SUMMARY OF THE INVENTION

It is a feature and advantage of the present invention to provide a method and system for token based user access authentication that enables secure user access to a web server using, for example, a smart card.

It is a further feature and advantage of the present invention to provide a method and system for token based user access authentication that allows improved management of access to a particular web server.

To achieve the stated and other features, advantages and objects, an embodiment of the present invention provides a method and system for token based user access authentication which makes use of the token authentication process of the single sign-on mechanism, but does not employ a user name and password in the log on process. Instead, an embodiment of the present invention makes use of a smart card with a certificate which allows the user to log on by authenticating himself or herself to the smart card with a Personal Identification Number (PIN). The smart card then uses a mutual authentication to verify the identity of cardholder and the access server and establish a secure link between client terminal to access server with the Secure Sockets Layer (SSL) protocol.

An embodiment of the present invention provides a method and system for token-based authentication in an environment of single sign-on access for a user to a federation of web servers. The method enables authentication at an entity's web site server, selection of a service provider URL, and passage of a one-time perishable authentication token by the entity's web site server to a service provider's server. The token contains sufficient information to enable the service provider's server to recognize the entity as a valid service provider user, and may take the form of a cookie that can be shared across domains. An exemplary system may be an online brokerage firm with accompanying bill payment services provided at a separate domain.

According to an embodiment of the method of token-based authentication of the present invention, the user with a token, such as a smart card, at a workstation, such as a client terminal or other computing device, such as personal computer or a web-enabled wireless device with a card reading device, is authenticated by an application, for example, on the smart card. The user authenticates to the application on the token, such as the smart card, by entering the user's personal identification number or other identifying information at the workstation. A mutual authentication is established between the client workstation and an access server, such as the access server for an online banking system, coupled to the client workstation over a network, such as the Internet, using a digital certificate which is stored on the token, such as the smart card.

The mutual authentication process for an embodiment of the present invention, involves reading out the digital certificate by invoking a browser on the client workstation to retrieve the digital certificate from the smart card. In the mutual authentication process, the user with the smart card is allowed to access the browser at the client workstation to retrieve a smart card logon page which resides on the access server. The smart card logon page is a secure web site via Secure Hypertext Transfer Protocol that contains codes to invoke the browser at the client workstation for reading contents of the smart card and is a web site that is configured to require both Secure Sockets Layer Protocol server authentication and Secure Sockets Layer Protocol client authentication. The smart card logon page reads and sends the cardholder's digital certificate which has the logical card ID number imbedded from the smart card to the access server via a network, such as the Internet, using a Secure Sockets Layer Protocol link between the browser at the client workstation and the access server.

In an embodiment of the present invention, the digital certificate is validated against a database of the access server to verify that the token, such as the smart card, hence the certificate, is valid. The digital certificate validation process involves validating the logical card-ID of the smart card against the access server database to verify that the smart card is not invalid and is found in the access server database. Upon validating the digital certificate, authentication of the user is confirmed, and the logical card-ID returned from the smart card is mapped into a system user ID by the access server, based on mappings stored in the access server database. The access server also generates at least one authentication cookie which indicates a server, such as the access server, that the user is entitled to use for logging on and at least one additional server, such as an online banking system server, that the user is entitled to access with the authentication cookie;

The authentication cookie for an embodiment of the present invention is encrypted by a private key associated with a server certificate of the access server, and a time stamp is associated with the authentication cookie by the access server. The access server can also generate multiple authentication cookies which indicate any number of additional servers, such as a federation of web servers, that the user is entitled to access with the authentication cookie. The access server sends the authentication cookie or cookies to the browser of the client workstation and redirects the browser at the client workstation to one or more additional servers, such as the online banking system server. The additional server or servers verifies the authentication cookie for access for the user to the additional server or servers, such as the online home banking system server. Verification of the authentication cookie involves, for example, reading the authentication cookie by the home page of the online banking system server, retrieving the online banking system user ID, and performing a trusted logon on behalf of the user.

Additional objects, advantages and novel features of the invention will be set forth in part in the description which follows, and in part will become more apparent to those skilled in the art upon examination of the following, or may be learned by practice of the invention.

### BRIEF DESCRIPTION OF THE DRAWINGS

FIG. 1 is a schematic diagram which shows an example overview of key components and the flow of information between key components for the token-based authentication system for an embodiment of the present invention;

FIG. 2 is a schematic diagram which shows an example overview of key components and the flow of information between key components for the token-based authentication system utilizing a wireless device for an embodiment of the present invention;

FIG. 3 is a schematic diagram which illustrates an overview example of key components and the flow of information between the key components for the token-based authentication system in an online banking system for an embodiment of the present invention;

FIG. 4 is a schematic flow chart which illustrates an example of the authentication process for the online banking aspect for an embodiment of the present invention; and

FIG. 5 is a flow chart which illustrates functionality for the authentication process of the online banking aspect provided by an embodiment of the present invention.

### DETAILED DESCRIPTION

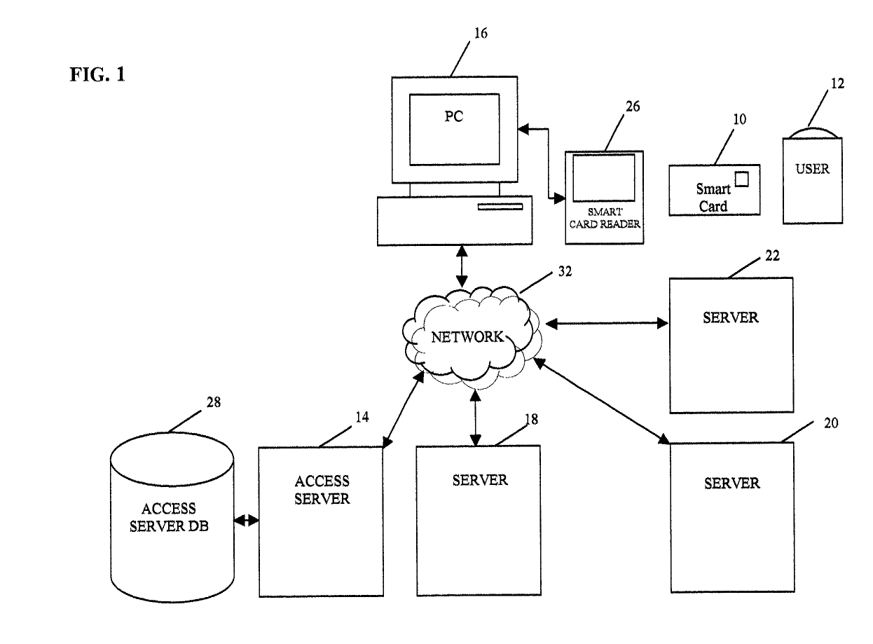

Referring now in detail to an embodiment of the invention, an example of which is illustrated in the accompanying drawings, FIG. 1 is a schematic diagram which shows an example overview of key components and the flow of information between key components for the token-based authentication system for an embodiment of the present invention. An embodiment of the present invention utilizes the token authentication of the single sign-on mechanism but goes beyond that process. Referring to FIG. 1, instead of using a user name and password to log in, an embodiment of the present invention makes use of a smart card 10 with a certificate. The smart card 10 with the certificate allows a user 12 to log in with the smart card 10 using mutual authentication with the proper key to authenticate the smart card 10.

Referring further to FIG. 1, once the cardholder 12 authenticates himself or herself to the smart card 10 using the cardholder's PIN, the card 10 establishes a mutual authentication with an access server 14 using SSL protocol authentication. Thereafter, the access server 14 generates an authentication token or cookie and returns the cookie to the browser of the cardholder's client workstation 16. When the authentication cookie is returned, the cardholder 12 can then proceed from the client workstation 16 onto another server, such as one of servers 18, 20, and/or 22. Thus, an embodiment of the present invention extends the original concept of the single sign-on mechanism.

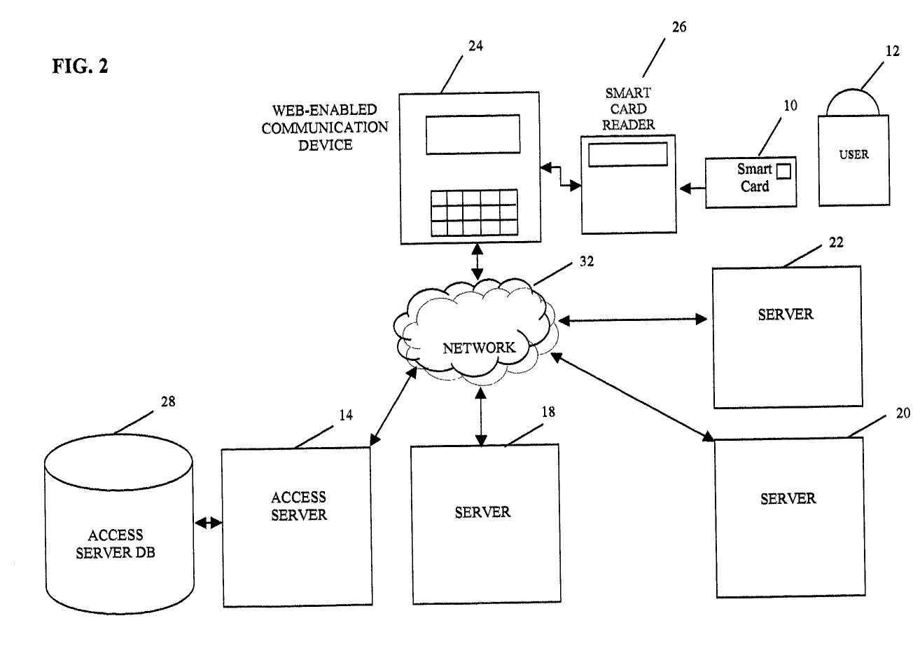

An aspect of an embodiment of the present invention also makes use, for example, of the same smart card with a different platform, such as a cell phone, to access the same web server with the same solution. FIG. 2 is a schematic diagram which shows an example overview of key components and the flow of information between key components for the token-based authentication system utilizing a wireless device for an embodiment of the present invention. Typically, users of wireless devices, such as web enabled wireless phones, have difficulty entering a user name and password because, for example, the cell phone keypad and display are very small. An embodiment of the present invention allows the cardholder 12 to access the web server 14 simply by entering the user's PIN once, and the rest of the process is automatic. In this aspect, the cell phone 24 is provided with a dual slot 26, so the cardholder 12 can use the smart card 10 to perform transactions and the like, while the other slot can be used for normal cell phone access control and security.

In an embodiment of the present invention, an Internet Service Provider (ISP) is dialed up, and from the ISP the first server 14 is selected. Thereafter, the smart card 10 takes care of the authentication and allows the cardholder 12 to access the second server, such as one of servers 18, 20, and/or 22. An embodiment of the present invention makes use of smart card technology to improve security, because the certificate based logging in according to an embodiment of the present invention is far more secure in the virtual world than, for example, using a user password and log in name. An embodiment of the present invention makes use of the single sign-on mechanism approach in which the user 12 logs on to the first web server 14, and the first server 14 generates an authentication cookie. However, an embodiment of the present invention utilizes the smart card 10 to perform the mutual authentication and log on to the first server 14. Once that is accomplished, the same authentication cookie is generated and used to access the second server, such as server 18, 20 and/or 22.

Referring again to FIG. 1, an embodiment of the present invention makes use, for example, of a user workstation or client workstation 16 on the user side and an access server 14 on the server side. Each user workstation 16 is equipped with a smart card reader 26 and associated software. The software includes the smart card reader driver for the operating system, and any suitable operating system, such as Windows NT or Windows 95/98, can be employed. An embodiment of the present invention also uses, for example, a standard browser, such as NetScape Communicator, plug-in to allow the browser to access the smart card 10. The access server 14 uses an Active Server Page (ASP) to communicate with the smart card 10, and to allow the smart card 10 to perform its functions. In an embodiment of the present invention, the user 12 first gets onto the system and uses the smart card PIN to unlock the smart card 10. Once the smart card 10 is unlocked, the workstation 16 reads out the digital certificate which is stored on the smart card 10. The digital certificate is used to perform a mutual authentication with the access server 14 which has a server certificate. The access server 14 and the workstation 16 exchange the certificate and establish a SSL secure link between the access server 14 and the workstation 16.

Once the cardholder 12 is verified and the certificate is found to be valid and not, for example, revoked or otherwise invalid, the access server 14 generates an authentication cookie. The authentication cookie is encrypted by the private key associated with the server certificate. The server private key-encrypts the authentication cookie, a time stamp is associated with the authentication cookie, and the authentication cookie is returned to the client workstation 16. The authentication cookie for an embodiment of the present invention also indicates which server, such as one of servers 18, 20, or 22, that the particular user is entitled to use for logging on. The cookie indicates the particular server that the user is entitled to access with the particular authentication cookie. An aspect of an embodiment of the present invention also includes the use of single access to multiple servers, such as more than one of servers 18, 20, and/or 22, in which case the access server 14 generates multiple authentication cookies, depending on the entitlement of the user 12.

When the client workstation 16 receives the particular authentication cookie, the URL page is redirected to the second server selected, for example, from one of servers 18, 20, or 22. The second server 18, 20, or 22 checks the authentication cookie, for example, to verify the cookie and to allow the user to access the second server. The second server 18, 20, or 22 can be, for example, a credit card file server that allows the user to check the user's credit card account status and perform a payment or the like. The access server 14 has a database 28 to verify, for example, that the card 10 is not on a “hot list,” and the server script routine validates the particular card 10 against the access server database 28. The access server 14 can be any kind of web server which can support the certificate based authentication. In addition to the regular authentication server script, an embodiment of the present invention includes enrollment and Help Desk server script. This provides system administration, for example, to enroll the cardholder 12 to a regular Internet connection, to resolve disputes or problems, or perhaps to revoke the cardholder's Internet activity.

In an embodiment of the present invention, the administration and the Help Desk access the access server 14 basically with the same approach of using a smart card 10 to authenticate using the SSL protocol. While the single sign-on mechanism uses one-way SSL in which the server certificate is used to enter the proper key, an embodiment of the present invention uses two-way mutual authentication, in which the SSL is on both sides. With SSL on both sides, the exchange of authentication information is more secure, so that the user 12 is better protected from the so-called man-in-the-middle attack. The card identification is established when the user 12 is enrolled and the card is issued.

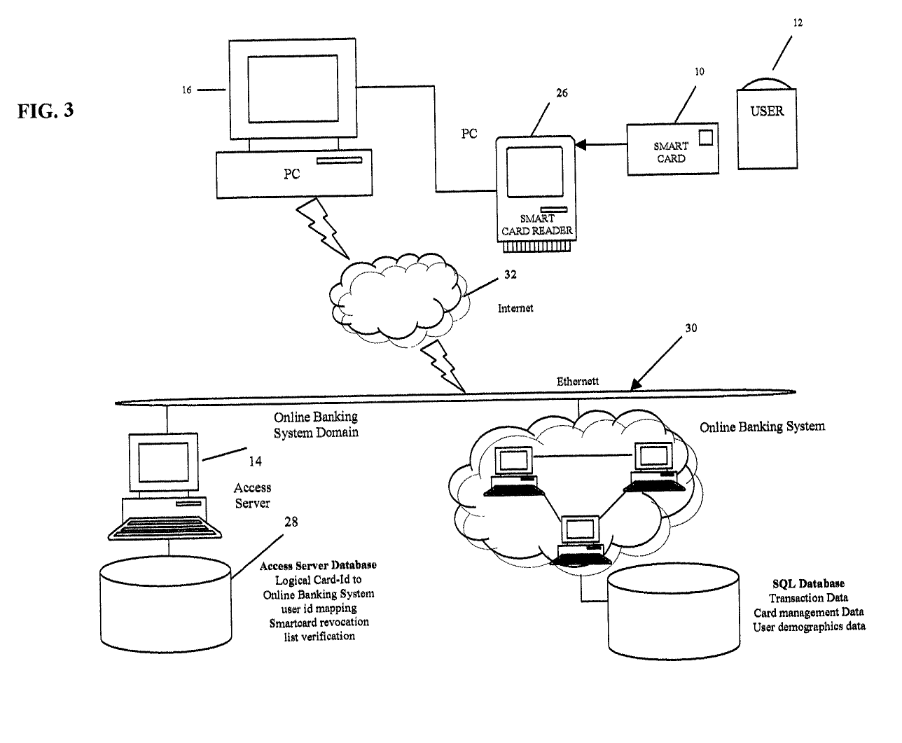

An online banking aspect of an embodiment of the present invention provides a token based authentication solution for secure access to a web site, for example, for an online banking system, which utilizes a smart card solution as one aspect of end-to-end e-commerce solutions, including electronic purchasing, payments, settlement, reconciliation, and ready access to information. FIG. 3 is a schematic diagram which illustrates an overview example of key components and the flow of information between the key components for the token-based authentication system in an online banking system for an embodiment of the present invention. The smart card 10 provides a superior level of security for such e-commerce solutions and to provide an increased security and improved management of the access of the user 12 to the web site, such as the online banking system 30. A variety of additional features can be consolidated into one card 10, such as secure sign-on and on-contact physical access through biometrics, such as fingerprints, migration from magnetic stripe cards toward chip-based credit or debit features, contactless facility access, property management such as the loan of equipment, personal and/or health and medical data, via data storage, electronic purse (stored cash value), travel and entertainment programs (such as preferred travel rates and other offerings), and loyalty programs.

The smart card solution for an embodiment of the present invention is managed, for example, by a financial institution, such as a bank. Thus, the bank procures, configures and deploys the workstations, such as PC 16, as well as manages the access server 14 and a security manager workstation, which are required for the solution. In a worldwide aspect of the solution for an embodiment of the present invention, the management of the access server 14 and the security manager workstation can be managed by the bank or by a client whose employees, such as user 12, use the system 30. The bank installs the workstation, such as PC 16, at each of the client sites. The workstations, such as PC 16, are configured at the bank and provided to the client for shipment to the participants. Upon receipt by each participant, the bank sends, for example, one or more implementation managers to each site for installation, testing and training. Each site is equipped with local internet access, for example, via an ISP, and an electrical outlet. Training includes, for example, smart card access overview, process flow, logon procedures, problem resolution, lost/stolen card procedures, understanding error messages, and online banking system features, functionality and reporting. The implementation managers are on-site at the pilot location for a predetermined period of time, for example, for installation and troubleshooting and for training.

In an embodiment of the present invention, authentication of the user 12 with the smart card 10 is accomplished by applying the SSL technique for client authentication. Each smart card 10 contains a user certificate, which is used to perform the SSL client authentication. The SSL-authenticated user 12 is further authenticated by the online banking system 30 through verification that the smart card 10, hence the certificate, is valid. This completes the authentication cycle from the transport level authentication to the application level authentication. An access server 14 is used to facilitate the authentication process. The access server 14 helps to de-couple the authentication function from the online banking applications. It also provides better scalability, availability, and extensibility for authorization implementation.

In the authentication process for an embodiment of the present invention, each user's workstation, such as PC 16, is equipped, for example, with Windows NT, a Personal Computer Memory Card International Association (PCMCIA) smart card reader 26 and associated software. The software that is installed includes, for example, a smart card reader driver for NT, integrated NT logon, and a Netscape plug-in for accessing the smart card 10. During a participant setup and training session, each user 12 chooses a unique PIN with up to eight American Standard Code for Information Interchange (ASCII) characters for the smart card 10. The smart card PIN is encoded to the online banking system access card 10 under the control of the user 12.

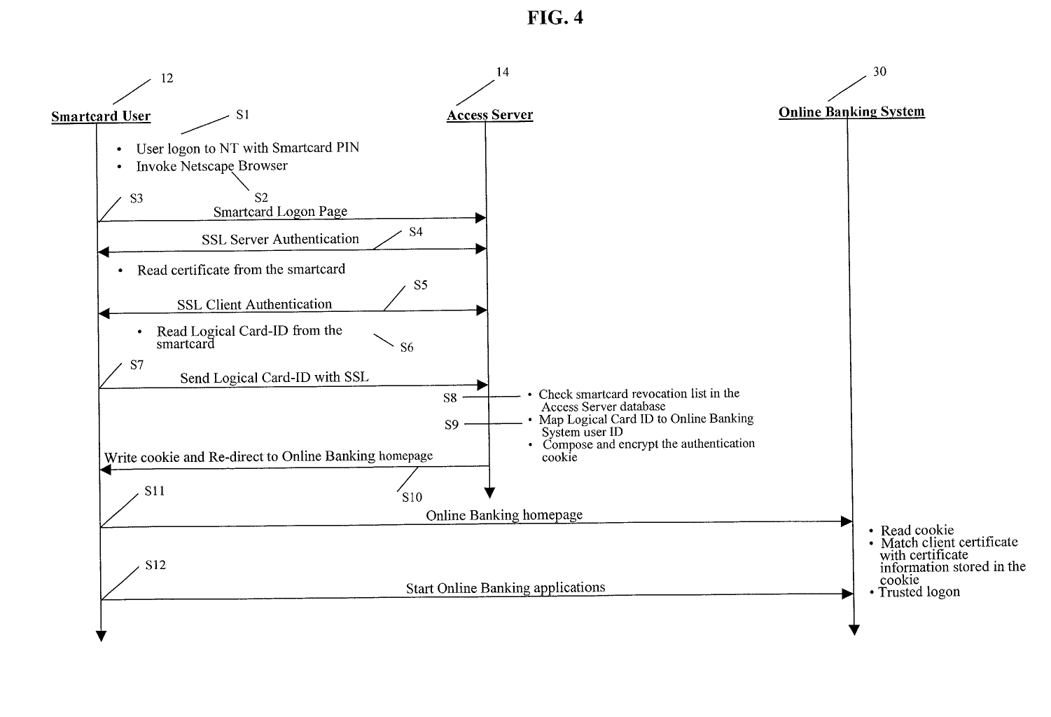

FIG. 4 is a schematic flow chart which illustrates an example of the authentication process for the online banking aspect for an embodiment of the present invention. Referring to FIG. 4, in the authentication process, at S1, the user 12 inserts the user's smart card 10 into the reader 26 and enters the user's unique smart card PIN, which unlocks the smart card 10 and logs the user 12 onto the workstation 16. As a result, the cardholder 12 authenticates to the smart card 10 and the smart card 10 authenticates to the workstation 16. Access to the online banking system 30 is controlled by the access server 14. To gain access to the online banking system 30, at S2, the smart card user 12 accesses the Netscape browser at the user's PC 16 to retrieve a special smart card logon page, which resides on the access server 14. The smart card logon page is a secure web site via Secure Hypertext Transfer Protocol (HTTPS).

The web site for an embodiment of the present invention is configured to require both SSL server authentication and SSL client authentication. The logon page also contains codes to invoke the Netscape plug-in for reading the contents of the smart card 10 at S3. SSL is established between the Netscape browser on the user's PC 16 and the online banking system access server 14. At S4, SSL server authentication is performed, and at S5, client authentication is performed. To facilitate the SSL client authentication using the client certificate, the smart card logon page invokes the Netscape plug-in to retrieve the digital certificate from the smart card 10. At S6, the smart card logon page reads the Logical Card-ID from the smart card 10, and at S7, the smart card logon page sends the Logical Card-ID to the access server 14 via a network, such as the Internet 32, through SSL.

Referring further to FIG. 4, at S8, a special Microsoft Internet Information Server (IIS) server script routine validates the particular Logical Card-ID against an access server database 28 to verify that the card 10 is not on the “hot card list” (e.g. lost, stolen or cancelled cards). If the ID of the card 10 is found in the online banking system banking access server database 28, the user 12 is a valid user, and the user 12 is considered authenticated. At S9, the access server 14 then maps the Logical Card-ID returned from the smart card 10 into an online banking system user ID, based on the mappings stored in the access server database 28.

Referring again to FIG. 4, at S10, the access server 14 writes an authentication token, in the form of a cookie, to the browser on the user's PC 16 and re-directs the browser to the online banking system home page. The online banking system user ID for the particular smart card user 12 is embedded in the authentication cookie. At S11, the online banking system home page reads the authentication cookie, retrieves the online banking system user ID, and performs a trusted logon on behalf of the authenticated user 12. At S12, the user 12 is logged onto the online banking system 30.

In an online banking system trusted logon aspect for an embodiment of the present invention, the online banking system 30 maintains a pair of user ID and password for each user 12, regardless whether the user 12 is a smart card enabled user or a regular user. When the smart card user 12 attempts to log onto the online banking system 30, the password checking is bypassed. Instead, the system 30 relies on the digital certificate in the smart card 10 for user authentication. To safeguard the password that is associated with the smart card user 12, when the smart card 10 is used to logon to the online banking system 30, the system 30 randomly generates a new password for the particular user 12. This prevents anyone, including the smart card holder 12, from logging on to a smart card user account on the online banking system 30 using a password.

In an aspect of embodiment of the present invention, when the smart card user 12 does not possess the smart card 10 (both the regular smart card and the backup smart card were lost, damaged, or returned for PIN reset), the smart card user 12 is temporary allowed to access the online banking system 30 through the regular access mechanism with user ID and password. The password is first reset by a customer service representative (CSR) following the existing operation guidelines for forgotten passwords. The first time the smart card user 12 logs onto the online banking system 30 using the user ID and password, the system 30 prompts the user 12 to change the password. The smart card user 12 continues to access the online banking system 30 until a new smart card is received. Subsequently, when the smart card 10 is used to access online banking system 30, the password is set to a randomly generated value and renders the user ID/password access mechanism unusable.

Under a normal situation, in an embodiment of the present invention, when the user 12 selects the online banking system smart card logon secure web page on the browser of the user's PC 16, the online banking system 30 performs a trusted logon after the certificate of the cardholder 12 has been verified. The access server 14 incorporates the online banking system user ID, for the authenticated user 12, into the authentication cookie. The online banking system user ID is passed from the access server 14 to the online banking system 30 in the authentication cookie. The online banking system code uses the online banking system user ID to log the user 12 onto the system 30. Every time a user 12 accesses the system 30 with the user's smart card 10, a new online banking system password is randomly generated and loaded to the system 30, for example, for password management and smart card operation support.

In a smart card management and user support aspect of an embodiment of the present invention, smart card issuance is completed by the bank, and each participant is issued two cards, one of which is for backup purposes. A smart card security manager workstation is installed at the bank for smart card management. The bank conducts on-site installation and training. During the training process, the cardholder 12 selects his or her unique smart card PIN of up to eight characters. When the smart card user 12 forgets his or her smart card PIN to unlock the smart card 10, the card 10 is returned to the bank for PIN reset.

In this aspect, lost smart cards are reported to the bank's online banking system Help Desk. The CSR puts the smart card ID on the “hot card list” to disable the lost card. At that time, the CSR enables a backup card. In addition, a replacement is issued and sent to the cardholder 12. If both cards are lost, the participant must call the online banking system Help Desk. The CSR resets the password for the user 12, following the banks standard operational procedures for resetting passwords for users that forget their password. The user 12 is then allowed to access the system 30 by using a regular online banking system user ID and refreshed password for a limited time. The user 12 is allowed to log onto the online banking system 30 using the online banking system user ID and password until the new smart card is received by the participant. Once the new smart card is received and used for the first time, the password is automatically re-generated by the online banking system 30. This prevents the smart card user 12 from using the online banking system user ID and password to gain access to the system 30.

Aspects of an embodiment of the present invention involve, for example, enabling the online banking system home page to read authentication cookies, the online banking system trusted logon, implementing the smart card logon page, incorporating authentication cookie management to the IIS ASP page, redirecting the browser of the user's PC 16 to the online banking system home page, incorporating IIS ASP routine into the access server 14, and mapping Logical Card-ID to the online banking system user ID. Additional aspects include, for example, setting up the access server database 28, installing a security manager workstation and training the online banking system Help Desk, issuing smart cards and loading certificates, acquiring and preparing client workstations, and installing client workstations and conducting user training. Other aspects include, for example, operating the Help Desk, operating the access server 14, and issuing replacement smart cards and disabling lost cards.

An embodiment of the present invention provides trusted logon from a smartcard authenticated user into the web site of the online banking system 30, while retaining the other functionality that currently exists for users of the system 30. As an example of current functionality, a user surfs to http://www.onlinebanking.com and a page is displayed for the user allowing the user to select the user's agency. After a selection is made, the user's browser is redirected to https://www.onlinebanking.com/default.asp?DIDX=xxxxxxxxxxxxxxx. The DIDX is the pointer in the registry that identifies the datasource and configuration information for the agency that the user has selected. The user is then presented with a logon page and prompted for the user's logon and password.

Continuing with the example of current functionality, upon entering the user's logon and password, the usename/password combination is verified against the database, and one of four occurrences is possible. A first possible occurrence is that the user is validated and redirected into the online banking system application. A second possible occurrence is that the user is notified that either the username or password is invalid and allowed to try again, up to three attempts, at which time the user is locked out of the system and only a CSR can reactivate the user. A third possible occurrence is that the user is notified that the account has been “locked out” and that the user must contact a CSR to reactivate the user. A fourth possible occurrence is that the user is asked to change his or her password, after successful completion of which the user is redirected into the online banking application.

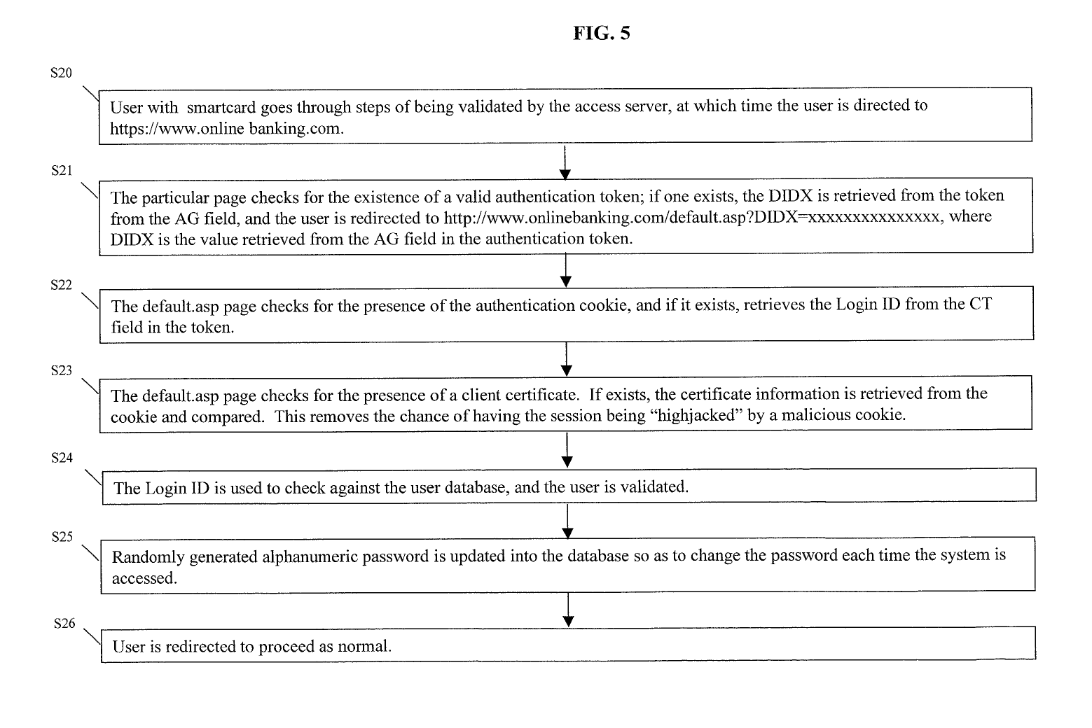

FIG. 5 is a flow chart which illustrates functionality for the authentication process of the online banking aspect provided by an embodiment of the present invention. At S20, the user 12 with the smart card 10 goes through steps of being validated by the access server 14, at which time the user 12 is directed to https://www.online banking.com. At S21, the particular page checks for the existence of a valid authentication token. If one exists, the DIDX is retrieved from the token from the AG field, and the user 12 is redirected to https://www.onlinebanking.com/default.asp?DIDX=xxxxxxxxxxxxxxx, where DIDX is the value retrieved from the AG field in the authentication token. At S22, the default.asp page checks for the presence of the authentication cookie, and if it exists, retrieves the Login ID from the CT field in the token. At S23, the default.asp page checks for the presence of a client certificate. If it exists, the certificate information is retrieved from the cookie and compared. This removes the chance of having the session being “highjacked” by a malicious cookie. At S24, this value is used to check against the user database 28, and the user 12 is validated. At S25, a randomly generated alphanumeric password is updated into the database 28 so as to change the password each time the system 30 is accessed. At S26, the user 12 is redirected to proceed as normal.

An embodiment of the present invention includes software that provides a means of utilizing encryption techniques, such as Entrust encryption techniques, to encrypt and digitally sign a string (hereafter referred to as a token) and return it to a parent application for use, for example, to set a cookie used for trusted logon. Additionally, the software decrypts and verifies the digital signature of a passed token and then returns the token to the host application. It should be noted that this document refers to Entrust encryption, which is provided with enhanced functionality, but does not purport to delineate how Entrust performs its functionality.

This software is dependent on a number of Dynamic Link Libraries (DLLs), which in most cases are located in the WINNT\SYSTEM32 directory of the host system. The DLLs on which this software is dependent include, for example, AUTHTOKEN.DLL, ENTAPI32.DLL, ETFILE32.DLL, GCSCRYPT.DLL, OLEAUTOLOG.DLL, and PVSREGKEY.DLL. AUTHTOKEN.DLL is an internally developed application in C++ which activates the ETFILE and ENTAPI DLLs and which must be registered in order to function properly. ENTAPI32.DLL is a third party vendor DLL provided by Entrust, the current version of which is 4.0i.0.207, that does not need to be registered, but must be located in the PATH.

ETFILE32.DLL is a third party vendor DLL provided by Entrust, the current version of which is 4.0i.0.207, that does not need to be registered but must be located in the PATH. GCSCRYPT.DLL is an internally developed application in C++ that uses triple Data Encryption Standard (DES) encryption to encrypt and decrypt a string. The key used is hard-coded into the application, and the particular DLL must be registered in order to function properly. OLEAUTOLOG.DLL is an internally developed application in C++ used for logging and debugging purposes. Logging level can be set through the registry and needs to be registered in order to function properly. PVSREGKEY.DLL is a third party vendor DLL provided by Procard as part of the Pathway product line. This DLL is used to access the registry but can be replaced with an internally developed object.

Exposed functions for the software include, for example, public function EncryptSign(strReceiver as string, strClear as string, strCrypt as string, Optional blnURLEncode as Boolean=False) as long. strReceiver is a string with no minimum or maximum length that specifies the name of the profile to which the token is being “sent” and which is also referred to as the token destination. strClear is a string with no minimum or maximum length that contains the clear text value of the token to be encrypted and signed. strCrypt is a string with no minimum or maximum length that is sent into the method (presumed to be empty) and returns with the value of the encrypted token to be passed to the external system. blnUrlEncode is a Boolean with default False that URL-encodes the strCrypt prior to exiting function if set to True and returns long, error code; 0=Success, non-0=Failure.

Exposed functions for the software also include, for example, public function DecryptVerify(strCrypt as string, strClear as string, strSender as string, Optional blnURLEncoded as Boolean=False) as long. strCrypt is a string with no minimum or maximum length that contains the encrypted value that one attempts to decrypt of which one attempts to verify the signature. strClear is a string with no minimum or maximum length that is sent into the method (presumed to be empty) and returns with the value of the clear text token to be utilized by the parent application. strSender is a string with no minimum or maximum length that is sent into the method (presumed to be empty) and returns with the value of the profile from which the token is being “received”, and which is also referred to as the token originator. blnURLEncoded is a Boolean with default False that causes the strCrypt to be URL-decoded prior to decryption and verification of the token, if set to true, and returns long, Error Code; 0=Success, non-0=Failure.

In an embodiment of the present invention, EncryptSign creates an instance of the AuthToken DLL that in turn activates the Entrust API and File Toolkit functions. EncryptSign uses the strReceiver value to look up in the registry to identify the information necessary to perform encryption and digitally sign the token. This information includes, but may not be limited to, the location of the ENTRUST.INI file, as well as the location of the key files, and profile passwords used for the encryption process. Each sender and/or receiver should have only one certificate, and all servers should have the exact same registry information, .INI files, DLL Files, and Entrust profiles/address books to ensure proper operation.

Entrust creates a token that is very large and makes it difficult to use efficiently, if at all. For example, IIS will not set a cookie that is larger that four kilobytes (KB) long, and most Entrust encrypted and signed strings are larger that that. Therefore, in an embodiment of the present invention, certain information is stripped out, which can be easily recreated from the .KEY files of the sender and receiver. The system then precedes this string with coded information that identifies the sender, receiver, and version information of the DLL that is encrypting and signing the data. When using IIS, in most cases this information will not need to be URL-encoded, which is the default. However, URL-encoding may be turned on if necessary for specific application purposes.

DecryptVerify simply reverses the process carried out by EncryptSign. DecryptVerify URL-decodes the string and utilizes the coded data at the beginning of the encrypted string to decide which sender has created the token. This information is then used to determine the value to look up in the registry to identify the information necessary to perform the decryption and digital signature verification. This information includes, but may not be limited to, the location of the ENTRUST.INI file, as well as the location of the key files, and profile passwords used for the encryption process. When using IIS, in most cases the token will not need to be URL-decoded, which is the default. However, URL-decoding may be turned on if necessary for specific application purposes.

The information contained in the registry is then used to open up the profile and key files for the sender and receiver to reconstruct the original token. An instance of the AuthToken DLL is then created that in turn activates the Entrust API and File Toolkit functions. The reconstructed encrypted value is passed to AuthToken, where the actual decryption and signature verification takes place. The returned value identifies which profile originated the token and the contents of the token in clear text.

Error return codes include 0 for no error or successful completion, and non-0 for error on execution or failure. Logging options include 0 for errors only, 1 for previous and token notification (displays encrypted token), 2 for previous and token notification (displays decrypted token), 3 for verbose, and 4 for ridiculous. The content of the log can be found in a file in WINNT\SYSTEM32 names OLEAutoLog-YYYY-MM-DD.log, and therefore a separate log file is created for each day's transactions. It should be noted that if there are other applications that are using the OLEAUTOLOG DLL, there will be other information contained in this log. The OLEAUTOLOG DLL reads, for example:

MACHINENAME processname DATE TIME CITITOKEN:LogInfo

The logging options are set in the registry key, for example:

\HKEY_LOCAL_MACHINE\SOFTWARE\CITITOKEN as a DWORD value called “LoggingLevel”, and if that value does not exist, then 0 (errors only) is assumed.

In an embodiment of the present invention, a “show source token” setting launches a notepad application on the server that is either doing the encryption or decryption and contains the token as Entrust sees it. “Show source token” is set in the registry key, for example:

\HKEY_LOCAL_MACHINE\SOFTWARE\CITITOKEN as a DWORD value called “ShowSourceToken” and if that value does not exist, then 0 (do not show source token) is assumed, otherwise, the source token is shown. A dummy mode setting basically disables encryption and decryption, and no matter what is passed to the functions, the exact same value is returned. In the case of EncryptSign, the return value is the concatenation of the sender, strReceiver and the clear text token separated by a ˆ character. In the case of DecryptVerify, the value passed in must be as described in EncryptSign above, but will return the strSender and clear text token in separate strings. The logging options are set in the registry key, for example

\HKEY_LOCAL_MACHINE\SOFTWARE\CITITOKEN as a DWORD value called “DummyMode”, and if that value does not exist, then 0 (standard mode) is assumed; otherwise, dummy mode is activated.

Various preferred embodiments of the invention have been described in fulfillment of the various objects of the invention. It should be recognized that these embodiments are merely illustrative of the principles of the present invention. Numerous modifications and adaptations thereof will be readily apparent to those skilled in the art without departing from the spirit and scope of the present invention.

What is claimed is:

1. A method of token-based authentication for a user, comprising:
authenticating the user at a client workstation by an application stored on the token;
establishing a mutual authentication between the client workstation and an access server using a digital certificate which is stored on the token;
validating the digital certificate against a database of the access server;
generating at least one authentication cookie by the access server which indicates a server that the user is entitled to use for logging on and at least one additional server that the user is entitled to access with the authentication cookie;
redirecting the browser at the client workstation to the at least one additional server; and
verifying the authentication cookie for access for the user to the at least one additional server.

2. The method of claim 1, wherein authenticating the user further comprises authenticating the user by the application stored on a smart card.

3. The method of claim 2, wherein authenticating the user further comprises authenticating the user with a personal identification number entered by the user at the client workstation which has a card reading device.

4. The method of claim 1, wherein authenticating the user at the client workstation further comprises authenticating the user at a client terminal.

5. The method of claim 1, wherein authenticating the user at the client workstation further comprises authenticating the user at a client web-enabled wireless device.

6. The method of claim 1, wherein establishing the mutual authentication further comprises establishing the mutual authentication between the client workstation and the access server for an online banking system.

7. The method of claim 1, wherein establishing the mutual authentication further comprises reading out the digital certificate which is stored on a smart card.

8. The method of claim 7, wherein establishing the mutual authentication further comprises invoking a browser on the client workstation to retrieve the digital certificate from the smart card.

9. The method of claim 8, wherein establishing the mutual authentication further comprises allowing the user with the smart card to access the browser at the client workstation to retrieve a smart card logon page which resides on the access server.

10. The method of claim 9, wherein establishing the mutual authentication further comprises allowing the user with the smart card to access the browser at the client workstation to retrieve the smart card logon page which is a secure web site via Secure Hypertext Transfer Protocol.

11. The method of claim 9, wherein establishing the mutual authentication further comprises allowing the user with the smart card to access the browser at the client workstation to retrieve the smart card logon page which contains codes to invoke the browser at the client workstation for reading contents of the smart card.

12. The method of claim 9, wherein establishing the mutual authentication further comprises allowing the user with the smart card to access the browser at the client workstation to retrieve the smart card logon page which is a web site that is configured to require both Secure Sockets Layer Protocol server authentication and Secure Sockets Layer Protocol client authentication.

13. The method of claim 12, wherein establishing the mutual authentication further comprises reading a logical card-ID from the smart card by the smart card logon page.

14. The method of claim 13, wherein establishing the mutual authentication further comprises sending the logical card-ID to the access server by the smart card logon page via a network using a Secure Sockets Layer Protocol link.

15. The method of claim 14, wherein establishing the mutual authentication further comprises sending the logical card-ID to the access server by the smart card logon page via a network using a Secure Sockets Layer Protocol link between the browser at the client workstation and the access server.

16. The method of claim 1, wherein validating the digital certificate against the database further comprises verifying that the token, hence the certificate, is valid.

17. The method of claim 16, wherein verifying that the token, hence the certificate, is valid further comprises verifying that a smart card, hence the certificate, is valid.

18. The method of claim 17, wherein validating the digital certificate further comprises validating a logical card-ID of the smart card against the access server database to verify that the smart card is not invalid.

19. The method of claim 18, wherein validating the digital certificate further comprises verifying that the logical card-ID of the smart card is found in the access server database.

20. The method of claim 19, wherein validating the digital certificate further comprises confirming that the user is authenticated.

21. The method of claim 20, wherein validating the digital certificate further comprises mapping the logical card-ID returned from the smart card into a system user ID by the access server based on mappings stored in the access server database.

22. The method of claim 1, wherein generating the authentication cookie which indicates the server that the user is entitled to use for logging on further comprises generating the authentication cookie which indicates that the user is entitled to use the access server for logging on.

23. The method of claim 1, wherein generating the authentication cookie which indicates the at least one additional server that the user is entitled to access further comprises generating the authentication cookie which indicates that the user is entitled to use at least an online banking system server.

24. The method of claim 1, wherein generating the authentication cookie further comprises encrypting the authentication cookie by a private key associated with a server certificate of the access server.

25. The method of claim 1, wherein generating the authentication cookie further comprises associating a time stamp with the authentication cookie by the access server.

26. The method of claim 1, wherein generating the authentication cookie further comprises generating multiple authentication cookies which indicate a plurality of additional servers that the user is entitled to access with the authentication cookies.

27. The method of claim 1, wherein generating the authentication cookie further comprises generating multiple authentication cookies which indicate a federation of web servers that the user is entitled to access with the authentication cookies.

28. The method of claim 1, wherein generating the authentication cookie further comprises returning the authentication cookie to the client workstation by the access server.

29. The method of claim 28, wherein generating the authentication cookie further comprises returning the authentication cookie to the browser of the client workstation.

30. The method of claim 1, wherein redirecting the browser to the at least one additional server further comprises redirecting the browser at the client workstation to at least an online banking system server.

31. The method of claim 30, wherein verifying the authentication cookie for access to the at least one additional server further comprises verifying the authentication cookie for access to at least the online home banking system server.

32. The method of claim 31, wherein verifying the authentication cookie further comprises reading the authentication cookie by a home page of the online banking system server.

33. The method of claim 32, wherein verifying the authentication cookie further comprises retrieving an online banking system user ID.

34. The method of claim 33, wherein verifying the authentication cookie further comprises performing a trusted logon on behalf of the user.

35. A system of token-based authentication for a user, comprising:
means for authenticating the user at a client workstation by an application stored on the token;
means for establishing a mutual authentication between the client workstation and an access server using a digital certificate which is stored on the token;
means for validating the digital certificate against a database of the access server;
means for generating at least one authentication cookie by the access server which indicates a server that the user is entitled to use for logging on and at least one additional server that the user is entitled to access with the authentication cookie;
means for redirecting the browser at the client workstation to the at least one additional server; and
means for verifying the authentication cookie for access for the user to the at least one additional server.

36. The system of claim 35, wherein the means for authenticating the user further comprises means for authenticating the user by the application stored on a smart card.

37. The system of claim 36, wherein the means for authenticating the user further comprises means for authenticating the user with a personal identification number entered by the user at the client workstation which has a card reading device.

38. The system of claim 35, wherein the means for authenticating the user at the client workstation further comprises means for authenticating the user at a client terminal.

39. The system of claim 35, wherein the means for authenticating the user at the client workstation further comprises means for authenticating the user at a client web-enabled wireless device.

40. The system of claim 35, wherein the means for establishing the mutual authentication further comprises means for establishing the mutual authentication between the client workstation and the access server for an online banking system.

41. The system of claim 35, wherein the means for establishing the mutual authentication further comprises means for reading out the digital certificate which is stored on a smart card.

42. The system of claim 41, wherein the means for establishing the mutual authentication further comprises means for invoking a browser on the client workstation to retrieve the digital certificate from the smart card.

43. The system of claim 42, wherein the means for establishing the mutual authentication further comprises means for allowing the user with the smart card to access the browser at the client workstation to retrieve a smart card logon page which resides on the access server.

44. The system of claim 43, wherein the means for establishing the mutual authentication further comprises means for allowing the user with the smart card to access the browser at the client workstation to retrieve the smart card logon page which is a secure web site via Secure Hypertext Transfer Protocol.

45. The system of claim 43, wherein the means for establishing the mutual authentication further comprises means for allowing the user with the smart card to access the browser at the client workstation to retrieve the smart card logon page which contains codes to invoke the browser at the client workstation for reading contents of the smart card.

46. The system of claim 43, wherein the means for establishing the mutual authentication further comprises means for allowing the user with the smart card to access the browser at the client workstation to retrieve the smart card logon page which is a web site that is configured to require both Secure Sockets Layer Protocol server authentication and Secure Sockets Layer Protocol client authentication.

47. The system of claim 43, wherein the means for establishing the mutual authentication further comprises means for reading a logical card-ID from the smart card by the smart card logon page.

48. The system of claim 47, wherein the means for establishing the mutual authentication further comprises means for sending the logical card-ID to the access server by the smart card logon page via a network using a Secure Sockets Layer Protocol link.

49. The system of claim 48, wherein the means for establishing the mutual authentication further comprises means for sending the logical card-ID to the access server by the smart card logon page via a network using a Secure Sockets Layer Protocol link between the browser at the client workstation and the access server.

50. The system of claim 35, wherein the means for validating the digital certificate against the database further comprises means for verifying that the token, hence the certificate, is valid.

51. The system of claim 50, wherein the means for verifying that the token, hence the certificate, is valid further comprises means for verifying that a smart card, hence the certificate, is valid.

52. The system of claim 51, wherein the means for validating the digital certificate further comprises means for validating a logical card-ID of the smart card against the access server database to verify that the smart card is not invalid.

53. The system of claim 52, wherein the means for validating the digital certificate further comprises means for verifying that the logical card-ID of the smart card is found in the access server database.

54. The system of claim 53, wherein the means for validating the digital certificate further comprises means for confirming that the user is authenticated.

55. The system of claim 54, wherein the means for validating the digital certificate further comprises means for mapping the logical card-ID returned from the smart card into a system user ID by the access server based on mappings stored in the access server database.

56. The system of claim 35, wherein the means for generating the authentication cookie which indicates the server that the user is entitled to use for logging on further comprises means for generating the authentication cookie which indicates that the user is entitled to use the access server for logging on.

57. The system of claim 35, wherein the means for generating the authentication cookie which indicates the at least one additional server that the user is entitled to access further comprises means for generating the authentication cookie which indicates that the user is entitled to use at least an online banking system server.

58. The system of claim 35, wherein the means for generating the authentication cookie further comprises means for encrypting the authentication cookie by a private key associated with a server certificate of the access server.

59. The system of claim 35, wherein the means for generating the authentication cookie further comprises means for associating a time stamp with the authentication cookie by the access server.

60. The system of claim 35, wherein the means for generating the authentication cookie further comprises means for generating multiple authentication cookies which indicate a plurality of additional servers that the user is entitled to access with the authentication cookies.

61. The system of claim 35, wherein the means for generating the authentication cookie further comprises means for generating multiple authentication cookies which indicate a federation of web servers that the user is entitled to access with the authentication cookies.

62. The system of claim 35, wherein the means for generating the authentication cookie further comprises means for returning the authentication cookie to the client workstation by the access server.

63. The system of claim 62, wherein the means for generating the authentication cookie further comprises means for returning the authentication cookie to the browser of the client workstation.

64. The system of claim 35, wherein the means for redirecting the browser to the at least one additional server further comprises means for redirecting the browser at the client workstation to at least an online banking system server.

65. The system of claim 64, wherein the means for verifying the authentication cookie for access to the at least one additional server further comprises means for verifying the authentication cookie for access to at least the online home banking system server.

66. The system of claim 65, wherein the means for verifying the authentication cookie further comprises means for reading the authentication cookie by a home page of the online banking system server.

67. The method of claim 66, wherein the means for verifying the authentication cookie further comprises means for retrieving an online banking system user ID.

68. The method of claim 67, wherein the means for verifying the authentication cookie further comprises means for performing a trusted logon on behalf of the user.
